(19) United States
(12) Patent Application Publication
(10) Pub. No.: US 2018/0121585 A1
(43) Pub. Date: May 3, 2018

(54) GRAPH BASED DYNAMIC TIMING AND ACTIVITY ANALYSIS

(71) Applicant: Regents of the University of Minnesota, Minneapolis, MN (US)

(72) Inventors: Hari Cherupalli, Austin, TX (US); John Sartori, Minnetrista, MN (US)

(73) Assignee: Regents of the University of Minnesota, Minneapolis, MN (US)

(21) Appl. No.: 15/800,330

(22) Filed: Nov. 1, 2017

Related U.S. Application Data
(60) Provisional application No. 62/415,623, filed on Nov. 1, 2016.
(60) Provisional application No. 62/415,614, filed on Nov. 1, 2016.

(51) Int. Cl. G06F 17/50

(52) U.S. Cl. CPC G06F 17/5031; G06F 17/5045

(57) ABSTRACT

A method for analyzing a digital circuit includes performing a hardware simulation for a workload on a digital circuit design to generate an activity file including a plurality of time stamps and a list of gates, nets, pins, or cells that toggled at each corresponding time stamp. The method includes generating a toggled-set for each time stamp in the activity file and analyzing a vertex-induced sub-graph defined by each toggled-set. The method includes determining a characteristic of the digital circuit design over a specified time window based on the analysis of each toggled-set.

### CROSS-REFERENCE TO RELATED APPLICATIONS

This Non-Provisional Patent Application claims the benefit of the filing date of U.S. Provisional Patent Application Ser. No. 62/415,614, filed Nov. 1, 2016, entitled “GRAPH BASED DYNAMIC TIMING AND ACTIVITY ANALYSIS” and U.S. Provisional Patent Application Ser. No. 62/415,623, filed Nov. 1, 2016, entitled “GRAPH BASED DYNAMIC TIMING AND ACTIVITY ANALYSIS,” the entire teachings of both of which are incorporated herein by reference.

### BACKGROUND

As challenges in technology scaling have resulted in increasing static and dynamic variations, along with increasingly restrictive design guardbands that ensure correctness even in the worst case, researchers have introduced better-than-worst-case (BTWC) design techniques that relax conservative design constraints, possibly at the expense of less than perfect correctness, in order to improve energy efficiency under average conditions.

BTWC design techniques rely on error tolerance or correction mechanisms to handle errors when worst case conditions occur, allowing a processor or other synchronous digital circuit to be optimized for and operated at a BTWC condition, potentially resulting in significant energy savings. Several BTWC design techniques exploit not only static design information, such as timing and power characterizations, but also dynamic information, such as activity factors, that describe how a design is used. Dynamic information describes which parts of a design are most likely to be exercised or to produce errors under BTWC conditions. Such information allows a designer to optimize for BTWC conditions, where errors may occur, and make a design more efficient in the face of errors. Since these techniques are used only for design optimization and not for timing closure, they do not require worst-case inputs for the simulated benchmarks.

Several BTWC design techniques have been proposed that exploit dynamic information characterizing the activity of paths in a design to perform optimizations and improve energy efficiency in variation-affected designs. A study of dynamic analysis-based design techniques reveals that all such techniques rely on path-based analysis and optimization methodologies. The distinguishing characteristic of these path-based methodologies is that the paths (or the exercised paths) in a design must be enumerated, individually analyzed, and optimized.

However, due to the very large number of paths in modern designs, path-based analysis and optimization become onerous and in most cases infeasible, even for small designs. Consequently, previously-proposed dynamic analysis and optimization techniques have been limited to working with only small design modules over small analysis time windows, due to the large computation time and memory requirements of path-based analysis and optimization. This has limited their applicability in modern semiconductor designs, which can often contain thousands of gates, and many orders of magnitude more paths. An additional consequence of this module-based approach is that paths between modules and paths that span multiple modules are ignored during analysis and optimization. Since it does not consider the full design, module-based analysis and optimization may produce incorrect or suboptimal results.

### SUMMARY

Disclosed herein is a novel dynamic analysis technique that is designed around graph-based, rather than path-based, analysis. The approach leverages the observations that a set of gates, nets, or pins in a design maps to a unique set of paths in the design. Thus, the exercised paths (identified by an input-based simulation) or exercisable paths (identified by a symbolic simulation) in a design can be characterized by identifying and analyzing the exercised or exercisable gates, nets, or pins. A novel methodology is described that leverages the speed and memory benefits offered by commercial static timing analysis (STA) engines to quickly characterize the dynamic critical path distribution of a design for a particular workload. The dynamic analysis tool can also characterize path activities for the design. Graph-based analysis significantly outperforms path-based analysis (e.g., by 105.6× based on experiments). Two optimizations are described that further improve the performance and reduce the memory footprint of the technique and the tradeoffs between the approaches are discussed. The graph-based dynamic analysis technique can efficiently analyze large designs over large time windows, even full processor designs, without ignoring parts of the design such as cross-module paths. Also described are methods to identify the N worst exercised paths from one or more gate-level simulations in decreasing order of criticality based on a metric.

### BRIEF DESCRIPTION OF THE DRAWINGS

FIG. 1 is an example circuit to illustrate theorem 1 and 2.

FIG. 2 illustrates one example of a SetTrie data structure used for fast superset lookups.

FIG. 3 illustrates one example of execution times for graph-based dynamic timing analysis (DTA) normalized to path-based DTA.

FIG. 4 illustrates one example of percentage reduction in the number of toggled-sets due to uniquification and Unique Non-Includible Toggled-sets (UNITs).

FIG. 5 is a flow diagram illustrating one example of a method for analyzing a digital circuit.

FIG. 6 is a flow diagram illustrating one example of a method to report a predetermined number of worst exercised paths of a digital circuit.

FIG. 7 is a block diagram illustrating one example of a processing system for implementing the methods described herein.

### DETAILED DESCRIPTION

One example provides a graph-based dynamic timing and activity analysis tool that reduces computation time and memory footprint compared to previously-proposed path-based analysis techniques. This is believed to be the first non-path-based dynamic analysis methodology.

Whereas path-based techniques are limited to analyzing small subsets of modules over small time windows (using considerable computation time and memory resources to do so), the tool described herein can process large synchronous digital circuit designs over large time windows, even full processor designs over full benchmark runs.

Optimizations that improve the performance of the dynamic analysis tool are also disclosed. Uniquification-based dynamic analysis reduces effort by 76.6%, and analysis based on Unique Non-Includible Toggled-sets (UNITs) reduces the effort by 83.9%.

Using the disclosed technique, up to 136.6× (105.6×, on average) speedup in runtime compared to a path-based analysis tool (even for a small design module over a small time window) is demonstrated and the benefits of the approach improve considerably with increasing design size or analysis time window.

Previous works that perform dynamic timing and activity analysis and optimization use path-based tools, such as micro-architectural techniques that trade-off variation-induced errors for power and performance of a processor. They rely on the VATS model (i.e., a model of timing errors due to parameter variation) which computes the dynamic slack distribution of a processor for a workload. Other works propose power-aware slack redistribution where paths are optimized based on timing criticality and toggle rate to improve power and area efficiency under voltage scaling. Yet other works propose a recovery-driven design methodology for optimizing a design for a specific target error rate. That methodology relies on path-based activity and timing analysis, and resizes gates to optimize a design on a path-by-path basis. Other works propose architectural optimizations to manipulate timing error rate behavior and increase the effectiveness of timing speculation while others propose compiler techniques that improve the energy efficiency of timing speculative processors.

The above BTWC techniques all rely on path-based timing and activity analysis, and many of the techniques also perform path-based design optimization. These techniques involve enumeration of paths and are not scalable, due to the extreme number of paths in electronic designs. As a result, application and evaluation of these techniques are limited to small modules and small analysis time windows. In addition to not being able to handle full designs, module sampling methodologies ignore paths between modules and those that cross module boundaries.

Since path-based techniques are not scalable, other works employ alternative techniques that either produce inexact results or do redundant work, such as running multiple gate-level simulations at different operating points for error rate computation. In contrast, the technique disclosed herein captures the path profile of a workload (or instruction sequence) in a single gate-level simulation, and the error rates at different operating points can be computed significantly faster by recomputing gate delays and performing STA. Other works propose a clustered timing model to capture the dynamic delay distribution of a processor. That approach requires manual analysis of the architecture and produces inexact results because of architectural approximations. In contrast, the technique disclosed herein is not only architecture independent, but it also does not introduce any approximations that degrade accuracy.

Before explaining the dynamic analysis techniques, some terms are defined and the necessary theorems to support the methodology are derived. The theorems in this section are applicable to graphs in general. However, they are applied to the context of a gate-level netlist of a digital design.

### Definitions

Given a design's gate-level netlist, the following is defined:
G→Graph of the design containing gates and nets.
p(A)→Set of all paths in the graph A.
g(A)→Set of all gates (vertices) in the graph A. (Note that the terms “gate” and “vertex” are used interchangeably in this disclosure. Also note that the techniques described herein also apply to pins and nets just as they apply to gates.)
f(A)→Set of path endpoints (flip-flops, clock gates, etc.) of the design represented by graph A. Note that f(A) is a subset of g(A), i.e., consider all path endpoints as gates.
pᵢ→A particular path.
gᵢ→A particular gate.

### Definition 1

Path: A set of gates {gₐ, g_{b}, . . . , gₙ} of a graph A can be considered a path if (1) an ordered sequence containing all the gates in the set can be formed such that each gate in the sequence is driven by the previous gate and (2) only the first and last gates of the sequence belong to f(A).

### Definition 2

Toggled gate: A gate is toggled in a particular cycle when the net that the gate is driving has changed values in that cycle.

### Definition 3

Toggled Path: A path is toggled in a particular cycle if all the gates in the path have toggled in that cycle.

### Definition 4

Non-Toggled Path: A path is non-toggled in a particular cycle if at least one gate in the path has not toggled in that cycle.

### Definition 5

Gate-set: A gate-set is any vertex-induced sub-graph of the graph G. (A vertex-induced subgraph is a subgraph defined by a set of vertices that contains all the edges between those vertices.)

### Definition 6

Toggled-set: A gate-set containing all the toggled gates of G and no non-toggled gates of G for a given time stamp is a toggled-set.

Theorems

Theorem 1: A toggled-set of a design's graph G contains all the toggled paths in G and does not contain any non-toggled paths.
Proof: Both parts of the theorem are proved by contradiction. Let A be a toggled-set of graph G containing all toggled gates for a particular analysis time stamp.

### Completeness:

Suppose there exists path p₁={g₁, . . . , gₙ} in p(G) such that p₁ has toggled but p₁∉p(A). This implies that at least one of the gates g₁, . . . , gₙ does not belong to g(A).
Let gₖ∉A, which implies gₖ has not toggled, since A, by definition, contains all toggled gates and no non-toggled gate.
This leads to a contradiction that path p₁ has not toggled, from the definition of a non-toggled path.

### Exclusivity:

Suppose path p₂={gₘ, gₘ₊₁, . . . , gₘ₊ₗ} is a non-toggled path such that p₂∈p(A). By definition of a non-toggled path, at least one gₘ, gₘ₊₁, . . . , gₘ₊ₗ has not toggled. This is a contradiction, since A contains only the toggled gates of G.

Note that the exclusivity clause of Theorem 1 assumes that (1) a net in a digital design is connected to the output pin of only one gate, and (2) every toggled input of a gate contributes to the toggle of the gate's output. The first assumption does not hold if the net is driven by multiple tri-state buffers. The second assumption does not hold for tri-state buffers driving multi-driven nets and multiplexers, which are considered as cells in certain cell libraries. It also does not hold in a case where a fast-arriving controlling input renders later-arriving toggles at other inputs ineffective. Since exceptions to these assumptions do not affect completeness, a toggled-set always completely characterizes the set of toggled paths. Techniques to maintain exclusivity even in these exceptional cases are discussed later in this disclosure.

Theorem 2: Let A & B be two gate-sets of a design's graph G. If g(A)⊆g(B) then p(A)⊆p(B).
Proof: Let path p₁ be a path {gᵣ, gₜ₊₁, . . . , gᵣ₊ₛ} such that p₁∉p(A) and p₁∉p(B).
This implies at least one of {gᵣ, gᵣ₊₁, . . . , gᵣ₊ₛ} does not belong to g(B), say gₜ.
Now, gₜ∈g(A) and gₜ∉g(B).
But g(A)⊆g(B), which is a contradiction, since all elements in g(A) must also be in g(B).
Corollary 1: If two toggled-sets A & B of a graph G have the same set of vertices (gates), then they have the same set of paths. This follows directly from Theorem 2.

### Examples

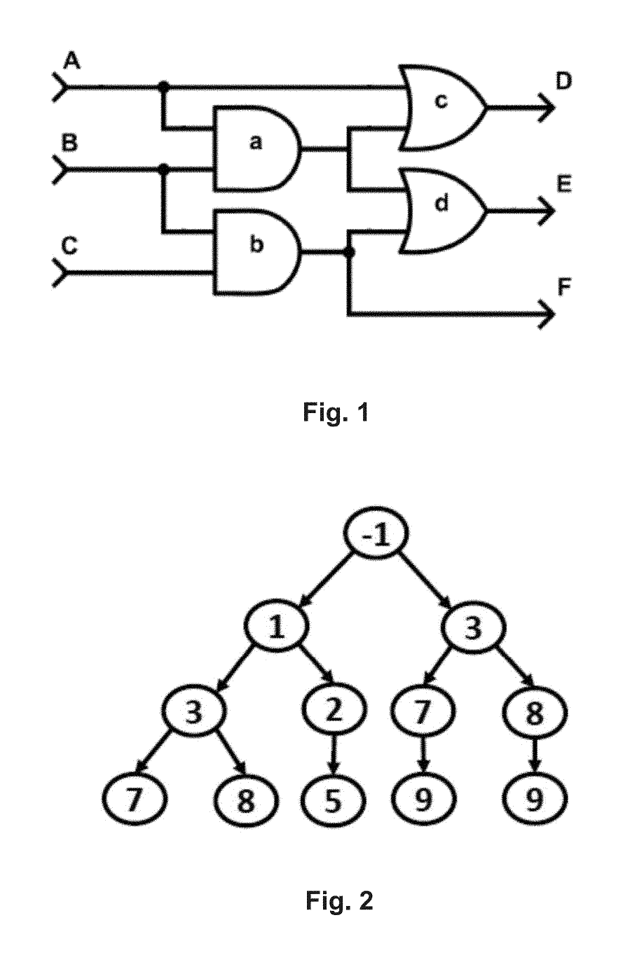

The above theorems are illustrated with an example for each theorem. Consider the circuit in FIG. 1. The ports A through F can be replaced with any of the legal endpoints for a path, such as flip-flops, clock-gates, etc. This circuit has 9 paths, as listed and indexed below.

| | |
|---|---|
| 1) | A, c, D |
| 2) | A, a, c, D |
| 3) | A, a, d, E |
| 4) | B, a, c, D |
| 5) | B, a, d, E |
| 6) | B, b, d, E |
| 7) | B, b, F |
| 8) | C, b, d, E |
| 9) | C, b, F |

To illustrate Theorem 1, assume that in a particular cycle ports A, C, D, E, F and gates b, c, d have toggled. This means that paths 1, 8, and 9 have toggled. However, any path containing gate a (paths 2, 3, 4 and 5) will not be considered in the sub-graph.

To illustrate Theorem 2, consider two different cycles. In one cycle, ports B, C, E, F and gates b, d have toggled while in another cycle, ports B, C, E, F and gates a, b, d have toggled. Clearly, the first set {B, C, E, F, b, d} is a sub-set of the second set {B, C, E, F, a, b, d}. Now the paths of the first set are {6, 7, 8, 9} while the paths of the second set are paths {5, 6, 7, 8, 9}. I.e., first set of paths is a subset of the second set.

VCD File

Dynamic timing analysis requires characterization of which gates or paths in a design are toggled, and potentially, how often they are toggled. A Value Change Dump (VCD) file may be used to obtain activity information for a design. A VCD file is generated by a gate-level simulation tool such as VCS when a workload is executed on the design. During gate-level simulation, whenever any net in the design toggles, VCS dumps the time stamp at which the toggle(s) occurred, followed by a list of all the nets that toggled along with their new values. Below is an excerpt from a VCD file. In the excerpt, nets a, b, and c toggle at time stamp 1500 from their previous values to 0, 1, 0, respectively. No net in the design toggles until time stamp 1800, at which time nets a, c, and d toggle to new values of 1, 1, 0, respectively.

### Contents of a VCD File

#1500
0a
1b
0c; Nets a, b, c toggle to 0, 1, 0 at time stamp #1500
#1800
1a
1c
0d; Toggled nets and new values at time stamp #1800
. . .

### Graph Based Dynamic Analysis

The graph-based approach to dynamic analysis is now presented. First, the basic technique is presented, followed by two optimizations that improve performance by eliminating redundant work.

Theorem 1 implies that a set of gates that toggle during a time stamp and the nets that they drive (a toggled-set) identify the set of all toggled paths for that time stamp, i.e., the toggled-set contains all the toggled paths and no non-toggled paths. As such, dynamic timing analysis (DTA) can be performed for a design by identifying the gates that toggle at a particular time stamp, ignoring all paths that do not pass through one of the toggled gates, and performing timing analysis (STA) on the vertex-induced subgraph defined by the toggled gates using a conventional CAD tool. The following steps describe the methodology.

1) Perform gate-level simulation for a workload on the design and generate an activity file (e.g., a VCD file).
2) For each time stamp in the activity file:
a) Read the toggled nets, mark the toggled gates (i.e., the gates driving the toggled nets) and generate a toggled-set.
b) Run activity or timing analysis (e.g., STA) on the vertex-induced sub-graph defined by the toggled gates (the toggled-set).

Marking and unmarking of gates for the purposes of timing analysis is achieved in commercial CAD tools such as PrimeTime using the commands reset_path and set_false_path, respectively. First, all gates are unmarked from timing analysis using set_false_path on every gate in the design and then the toggled gates are marked using reset_path. The pseudocode for this graph-based dynamic analysis algorithm is presented in Algorithm 1. While the dynamic analysis algorithms are presented for finding the dynamic critical path of a workload, they can apply dynamic (i.e., activity-based) analysis corresponding to any kind of static analysis that can be done using a commercial STA tool such as PrimeTime (e.g., statistical STA, on-chip variation analysis, crosstalk, etc.). Some of these analyses are discussed below.

Algorithm 1. Pseudocode for Basic Graph-based DTA

Procedure FindDynamicCriticalPath( )
1. Read netlist and initialize PrimeTime Tcl socket interface;
2. Open VCD File;
3. foreach Time stamp of activity t in the VCD do
4. Mark all gates as not toggled; // using set_false_path
5. Read Toggled nets
6. foreach Toggled net n do
7. Infer Toggled gate g that drives net n
8. Mark gate g as toggled // using reset_path
9. end for
10. Sₜ ← FindCriticalSlack( ) // using report_timing
11. if Sₜ < Sₘᵢₙ then
12. Sₘᵢₙ ← Sₜ
13. end if
14. end for

The method presented above can perform dynamic analysis (such as finding the dynamic critical path distribution) over any time window of interest, from a single cycle up to full application or multiple application runs. As demonstrated below, the graph-based dynamic analysis techniques achieve significant performance benefits over previously-proposed path-based techniques. Nevertheless, the graph-based approach affords even further opportunities for performance improvement, based on the following two observations.

1) The set of paths corresponding to a set of toggled gates is unique (see Corollary 1). I.e., two toggled-sets containing the same set of toggled gates also contain the same unique set of toggled paths.
2) A toggled-set that includes all the gates (i.e., is a superset) of another toggled-set also includes all its paths (see Theorem 2).
Based on these observations, the following optimizations are described.
1) Uniquification of the toggled-sets.
2) Unique Non-Includible Toggled-sets (UNITs) identification.

### Uniquification of Toggled-Sets

Since the set of toggled paths corresponding to a toggled-set is unique, dynamic analysis only needs to be performed once per unique toggled-set. Thus, redundant work can be avoided by storing and analyzing only the unique toggled-sets, instead of the toggled-sets for every time stamp. If the same toggled-set is observed at multiple time stamps, analysis (e.g., STA) of the toggled-set need not be repeated. Algorithm 2 describes uniquification-based dynamic analysis.

Algorithm 2. Pseudocode for Uniquification-based DTA

Procedure FindDynamicCriticalPath( )
1. // Toggled-set Uniquification
2. Read netlist and initialize PrimeTime Tcl socket interface;
3. Open VCD File;
4. Initialize List C // C is the set of all unique toggled-sets
5. foreach Time stamp of activity t in the VCD do
6. Read Toggled nets
7. foreach Toggled net n do
8. Infer Toggled gate g that drives net n
9. C ← insert(g) // C is the set of toggled gates
for the current cycle
10. end for
11. if C ∉ C then
12. C ← insert(C)
13. end if
14. end for
15. // Dynamic Timing Analysis
16. foreach C ∈ C do
17. Mark all gates as not toggled; // using set_false_path
18. foreach g ∈ C do
19. Mark gate g as toggled ; // using reset_path
20. end for
21. Sₜ ← FindCriticalSlack( ) // using report_timing
22. if Sₜ < Sₘᵢₙ then
23. Sₘᵢₙ ← Sₜ
24. end if
25. end for

While toggled-sets need not ever be repeated when a workload is executed on a processor, intuition argues that repetition of toggled-sets is likely to be common, even frequent, given that real workloads exhibit significant repetition of instruction and data use. Indeed, processors are designed with structures like caches precisely to take advantage of instruction and data reuse. Consider, for example, executing the loop in Listing 1 below. The jump instruction is executed to the same location 499 times, and the code in the loop body is executed in each of the loop's 500 iterations. The jump instruction, for example, excites the same paths in several stages of the processor (e.g., same decoding, same execution, etc.) each time it executes.

### Listing 1. Assembly Code for Simple Loop

mov #500, r5; loop 500 times
mov #0, r4; initialize loop counter
loop:
. . . ; loop body
inc r4; increment loop counter
cmp r5, r4; compare with loop limit
j1 loop; jump if counter<limit

Leveraging uniquification of toggled-sets to eliminate redundant work requires all unique toggled-sets to be stored before running DTA on each set. This increases the memory footprint of the tool. However, the additional memory requirement is negligible, even for long time windows, compared to the memory requirements of path-based techniques.

### Unique Non-Includible Toggled-Sets (UNITs) Identification

In this section, another optimization is presented that can improve the performance of DTA. When performing DTA for unique toggled-sets, it is not necessary to analyze any toggled-set that is a subset of another toggled-set. This is because, as stated in Theorem 2, if a gate-set A is a subset of another gate-set B, then the paths of A are also a subset of the paths of B. Thus, analyzing B will inherently involve complete analysis of A.

For an example of how UNITs may improve the efficiency of DTA, consider again the code in Listing 1. The paths exercised during an increment of r4 from 127 to 128 (0b1111111+1) are a superset of the paths covered during an increment from 31 to 32 (0b11111+1), since the former increment executes the same instruction but toggles more bits than the latter. Identification of UNITs can reduce the execution time and memory requirements of the DTA tool. Algorithm 3 describes UNITs-based dynamic analysis.

Algorithm 3. Pseudocode for UNITs-based DTA

Procedure FindDynamicCriticalPath( )
1. // UNIT Identification
2. Read netlist and initialize PrimeTime Tcl socket interface;
3. Open VCD File;
4. Initialize SetTrie Cₛₜ
5. Initialize List C
6. foreach Time stamp of activity t in the VCD do
7. Read Toggled nets
8. foreach Toggled net n do
9. Infer Toggled gate g that drives net n
10. C ← g // C is the set of toggled nets for the current cycle
11. end for
12. if ¬existsSuperSet(Cₛₜ, C) then
13. Cₛₜ ← insert(C)
14. C ← insert(C)
15. end if
16. end for
17. foreach C ∈ C do
18. if existsProperSuperSet(Cₛₜ, C) then
19. C ← delete(C)
20. end if
21. end for
22. // Dynamic Timing Analysis
23. foreach C ∈ C do
24. Mark all gates as not toggled; // using set_false_path
25. foreach g ∈ C do
26. Mark gate g as toggled ; // using reset_path
27. end for
28. Sₜ ← FindCriticalSlack( ) // using report_timing
29. if Sₜ < Sₘᵢₙ then
30. Sₘᵢₙ ← Sₜ
31. end if
32. end for

During UNITs identification, only the Non-Includible Toggled-sets are stored, that is, the toggled-sets that are not subsets of any other toggled-sets. A data structure called the SetTrie is used to perform fast subset and superset operations. The data structure is briefly explained below. SetTrie is just one way to identify UNITs, other ways to identify UNITs may be used.

1) SetTrie: A SetTrie is a data structure that is similar to the Trie data structure used for text searching. The Trie is designed for efficient substring searches while the SetTrie is designed for efficient subset and superset searches. Unlike Trie, SetTrie requires the elements of the universal set to be indexed. Element indices are inserted into the SetTrie such that a traversal path from the root to a leaf corresponds to a set of elements that is stored in the SetTrie. For example, the SetTrie in FIG. 2 stores the following sets.

| | |
|---|---|
| 1) | {1, 3, 7} |
| 2) | {1, 3, 8} |
| 3) | {1, 2, 5} |
| 4) | {3, 7, 9} |
| 5) | {3, 8, 9} |

The original SetTrie allows for any internal node to also act as the last element in the set, by using a flag for each node. This feature is not needed here, since UNITs require that a new set is inserted only if a superset does not already exist in the SetTrie.

To insert a set, first a check is performed to determine if there already exists a superset of the set being inserted. If this is the case, insertion is not performed. If the check reveals no superset, the tree is traversed down while the path of traversal matches exactly with the set being inserted and new nodes are created after the first point of deviation to accommodate the set being inserted.

Note that after a new set has been inserted, it would be useful to delete all the subsets of the new set. However, due to the exponential complexity of the getAllSubsets function, a different strategy is used. If a set is inserted successfully into the SetTrie, a copy of the set is stored in a separate list. Once all the sets have been inserted (VCD file parsing has been completed), a check is performed to determine if there exists a proper superset for each toggled-set stored in the separate list. If so, the toggled-set is deleted from the list of UNITs. For this purpose, the existsSuperset function is enhanced to existsProperSuperset. Note that there is no iteration over the entire list of toggled-sets again. The number of toggled-sets remaining after initial insertion is less than or equal to the number of unique toggled-sets and hence is significantly less than the number of parsed time stamps.

After removal of all sets that have a proper superset, a set of Unique Non-Includible Toggled-sets (UNITs) are left. These UNITs cover all the toggled paths of a workload. There may still exist redundancy between the UNITs, i.e., these sets may have a significant number of paths in common. However, elimination of this redundancy would require a path-based analysis which can be resource expensive, both in terms of time and memory.

The performance of the existsSuperset function is improved by checking gates with higher priorities (gates that are in more toggledsets) earlier in the SetTrie. This is achieved by indexing the gates in the following order of priority.

1) Clock Tree gates

### 2) Clock Gates

### 3) Flip-flops

### 4) Others

The idea behind this prioritized indexing is that gates that appear in many sets will be placed near the top of the SetTrie. Since a separate path in the SetTrie is only created after the first point of deviation between an inserted set and any existing set, storing gate indices that are common to many sets near the root of the tree results in a smaller tree, which in turn results in faster search times for the existsSuperset function.

For example, clock tree gates are commonly toggled at almost every time stamp and are prioritized to appear toward the top of the SetTrie. Low prioritization of clock tree gates would result in replicated entries near the leaves of the SetTrie for the clock tree gates in almost every set. High prioritization of clock tree gates, however, means that almost all sets stored in the SetTrie can use the same SetTrie nodes for the clock tree gates.

Extracting Live Toggled-Set from a Toggled-Set

A live toggled-set may be extracted from a toggled-set to reduce the number of unique toggled-sets or UNITs that need to be analyzed. The following definitions are used for this section.

### Definition 7

Dead Gate: A toggled gate in a cycle that is not part of any toggled path in that cycle is called a dead gate.

### Definition 8

Live Gate: A toggled gate in a cycle that is part of a toggled path in that cycle is called a live gate.

### Definition 9

Live Toggled-set: A Toggled-set with only live gates is called a Live Toggled-set.

A toggled-set can contain dead gates, and eliminating these dead gates would produce a live toggled-set. For a given toggled-set there can only be one live toggled-set.

If two toggled-sets have the same live toggled-set, then the two toggled-sets are equivalent in terms of path activity analysis, since they capture the same exercised paths. This leads to another opportunity to reduce the number of cycles of activity that need to be analyzed, since there can be two toggled-sets that have the same live toggled-set but different dead gates.

Algorithm 4 below is used to extract a live toggled-set from a toggled-set.

Algorithm 4. Pseudocode for Extracting
the Live Toggled-Set from a Toggled-Set

Function IsDeadToggle(g, C)
1. foreach fanout node fo ∈ fanout(g) do
2. if fo is a flip-flop or output port then
3. return false
4. end if
5. if fo ∈ C then
6. return false
7. end if
8. end for
9. return true
Function ExtractLiveToggledSet(C) // C is a toggled set
1. D ← Ø // Set of dead toggled gates
2. foreach toggled gate g in C do
3. if IsDeadToggle(g, C) then
4. D.push(g)
5. C.remove(g)
6. end if
7. end for
8. while D ≠ Ø do
9. gate g ← D.pop( )
10. foreach fanin gate fi ∈ fanin(g) and fi ∈ C do
11. if IsDeadToggle(fi, C) then
12. D.push(fi)
13. C.remove(fi)
14. end if
15. end for
16. end while
17. return C

Below, Algorithm 4 is described to extract a live toggled-set from a toggled-set.

1) This algorithm takes as input the design netlist and a toggled-set and outputs the live toggled-set of the input toggled-set.
2) A data structure is initialized which holds the set of dead gates that need to be analyzed to find other dead gates in the current toggled-set.
3) Iterate over all the gates in the toggled-set to identify dead toggled gates.

a. A dead gate can be identified by looking at its immediate fanout. If there is no live gate in the gate's immediate fanout that belongs to the toggled-set, then the gate can be considered to be a dead gate. An exception to this would be a gate whose immediate fanout contains a flip-flop or an output port, in which case the gate is considered to be a live gate. Once a gate is identified as a dead gate, it is removed from the toggled-set. This gate is pushed into a set of dead gates that need to be analyzed to determine if their fanin gates are also dead.

4) Once filling the set of dead gates is done, start analyzing the immediate fanins of each of these gates that belong to the toggled-set.
5) While the set of dead gates to analyze is not empty, do the following:

a. Remove a dead gate from the set of dead gates.

b. For each fanin gate of the removed gate, check if the fanin gate itself is a dead gate. If it is a dead gate, push it onto the set of dead gates to analyze and remove it from the toggled-set.

6) Keep iterating step 5 until the set of dead gates is empty. What is left is a live toggled-set of the input toggled-set.

### Toggle Rate of Paths

Path-based analysis and optimization techniques in previous works also determine and utilize the toggle rates of paths for power and performance optimizations. Since these techniques rely on path-based analysis, they enumerate paths and count the number of times each path has been toggled.

Although paths are not enumerated due to the high overheads involved, the technique disclosed herein still allows for an efficient approach to finding path toggle rates. Namely, the toggle rate of a path can be found by summing the toggle rates of all the unique toggled-sets the path belongs to. A path belongs to a toggled-set if the set of gates in the path is a subset of the set of gates in the toggled-set. Thus, the getAllSupersets function of a SetTrie containing all the unique toggled-sets can be used to determine which unique toggled-sets a path belongs to. The toggle rate of a unique toggled-set can easily be determined by maintaining a counter for each unique toggled-set during VCD parsing. Each time a toggled-set is encountered at a time stamp, the counter for the set is incremented, indicating that all the paths in the toggled-set have toggled at that time stamp.

A tradeoff exists between uniquification of toggled-sets and UNITs. UNITs produces (sometimes significantly) fewer toggled-sets to analyze than uniquification and can perform analysis faster. However, UNITs discards information about the subsets that have been merged into a superset, and thus it is not possible to determine path toggle rates from UNITs-based analysis. I.e., a UNIT may encompass the information for more than one unique toggled-set, so determining the toggle rate of each unique toggled-set is not possible for a UNIT.

One way to get the benefits of both methods (activity analysis possible with uniquification and increased efficiency of UNITs) is to maintain unique toggled-sets information for activity analysis and perform subsetting on the unique toggled-sets and use UNITs-based timing analysis on the dynamic critical paths. Note that enumerating and analyzing all the toggled paths is not needed as in path-based analysis. E.g., the focus can be on only the critical/near-critical paths reported by the DTA methodology.

### Methodology

The techniques described above were verified with experiments on a silicon-proven processor—openMSP430. Designs were synthesized, placed, and routed with TSMC 65GP library (65 nm), using Synopsys Design Compiler and Cadence EDI System assuming worst-case operating conditions. Gate-level simulations were performed by running full benchmark applications from Table I on the placed and routed processor using Synopsys VCS. Activity information was read from the VCD file generated from gate-level simulation. Timing analysis was performed with Synopsys PrimeTime. Experiments were performed on a server housing two Intel Xeon E5-2640 Processors with 8-cores each, 2 GHz operating frequency, and 64 GB RAM. The algorithms were implemented in C++. For comparison against path-based DTA, a path-based tool was implemented.

TABLE I
Benchmark Descriptions

| | |
|---|---|
| Mult | Integer Multiplication |
| Tea8 | 8-bit Tiny Encryption Algorithm |
| binSearch | Binary Search |
| rle | Run-Length Encoding Algorithm |
| intAVG | Integer Average |
| inSort | Insertion Sort |
| tHold | Threshold Cross Detection |
| div | Integer Division and Outputting |
| intFilt | FIR Lowpass Integer Filter |
| dhrystone_v2.1 | Dhrystone Benchmark |
| dhrystone_4mcu | Dhrystone Benchmark for MCUs |
| coremark_v1.0 | Coremark Benchmark |

### Results and Analysis

To illustrate the benefits of the graph-based analysis over path-based analysis, the computation time (in seconds) was compared for each technique to perform dynamic timing analysis of the processor. This involved running a benchmark on the processor, characterizing all the toggled paths in the design, and finding the critical timing path among the toggled paths.

With an attempted run of the path-based tool for the full processor and a benchmark with relatively low activity (div), after two hours of computation the server (with 64 GB of RAM) ran out of memory and was only able to analyze paths for a time window of 25 cycles in the VCD file. For a benchmark with higher activity (coremark_v1.0) and thus more toggled paths, the path-based tool was not even able complete analysis for one cycle before running out of memory.

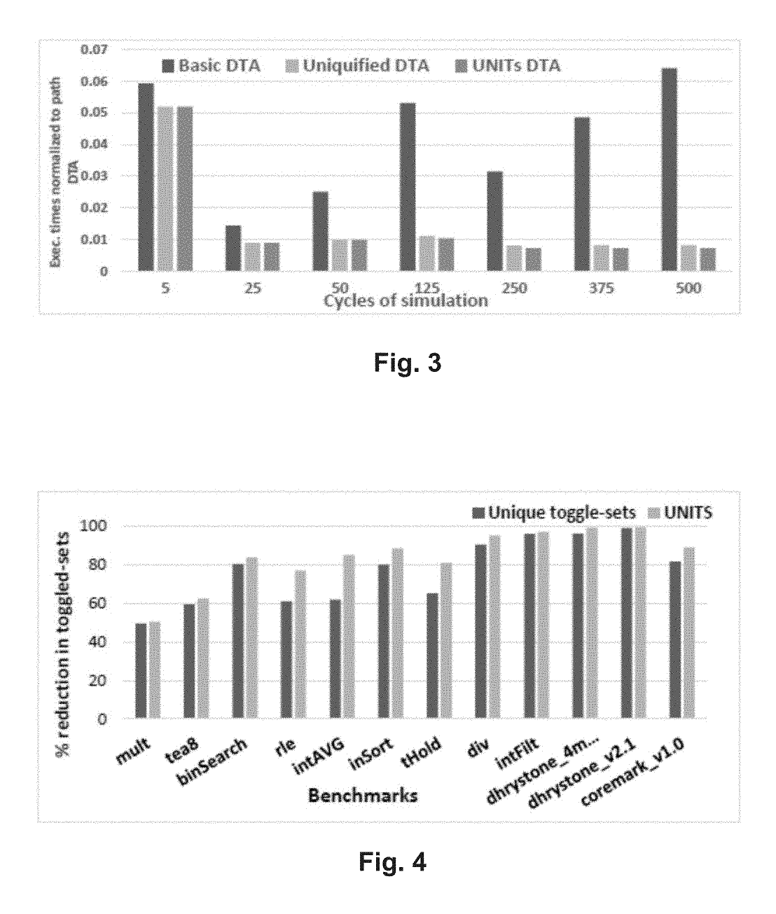

Due to the high memory and computation time requirements of path-based analysis, a comparison could only be performed for a processor module (not the full processor). Note that previous works that use path-based analysis are likewise limited to analyzing only small modules. Table II compares the runtime of path-based DTA for the execution unit of openMSP430 and the div benchmark against three approaches described herein. FIG. 3 shows the performance data for the approaches normalized to that of path-based analysis. Table II and FIG. 3 show data for different time windows of execution (in cycles), demonstrating that even for a single module the performance benefit of graph-based analysis is significant (up to 136.6×, 105.6× on avg.) and increases for larger time windows. Note that even for single-module analysis over these short time windows the computation time of path-based analysis quickly becomes unreasonable. While it can be seen that UNITs is faster than uniquification-based DTA, the next set of results makes a more convincing case for UNITs.

TABLE II
Computation Times (Seconds) for Path-Based DTA and the Proposed
Techniques at Different Length of Time Windows (Cycles)

| | Time window (cycles) | | | | | | |
|---|---|---|---|---|---|---|---|
| | 5 | 25 | 50 | 125 | 250 | 375 | 500 |
| Path-based DTA | 135 | 1455 | 1516 | 1527 | 5054 | 5105 | 5326 |
| Basic DTA | 8 | 21 | 38 | 81 | 159 | 248 | 341 |
| Uniquified DTA | 7 | 13 | 15 | 17 | 41 | 42 | 44 |
| UNITs DTA | 7 | 13 | 15 | 16 | 37 | 37 | 39 |

The next set of results compares the performance benefits offered by the two DTA optimizations for full processor analysis and full application execution of the benchmarks in Table I. I.e., the analysis time window spans the full execution of the benchmark on the full processor. Note that this full level of analysis, which would be expected of a commercial CAD tool, is enabled by the graph-based analysis approach and is not possible for path-based analysis. Execution time profiling (e.g., gprof) revealed that the time taken to unmark all gates, mark all toggled gates, and report the critical timing path is approximately the same for any given toggled-set, and on average, these steps consume over 90% of total analysis time. Thus, the primary performance benefit of the optimizations comes from reduction of the number of toggled-sets that must be analyzed. Table III shows the number of toggled-sets identified for analysis by basic graph-based DTA (Algorithm 1), uniquification-based DTA (Algorithm 2), and UNITs-based DTA (Algorithm 3). FIG. 4 shows the percentage reduction in the number of toggled sets for the two optimized DTA techniques, relative to basic graph-based DTA.

TABLE III
Number of Toggled-Sets Identified for Analysis by
Each DTA Approach

| | Basic DTA | Unique | |
|---|---|---|---|
| Benchmarks | toggled-sets | toggled-sets | UNITs |
| mult | 147 | 74 | 73 |
| tea8 | 4191 | 1704 | 1579 |
| binsearch | 4723 | 925 | 764 |
| rle | 5848 | 2318 | 1372 |
| intAVG | 12308 | 4704 | 1849 |
| inSort | 28813 | 5762 | 3333 |
| tHold | 28870 | 10016 | 5508 |
| div | 68801 | 6594 | 3387 |
| intFilt | 222495 | 8559 | 6547 |
| dhrystone_4mcu | 332977 | 12773 | 2908 |
| dhrystone_v2.1 | 478429 | 4703 | 2818 |
| coremark_v1.0 | 980930 | 180695 | 108379 |

Table III and FIG. 4 demonstrate significant reduction in toggled-sets for both uniquification and UNITs. Uniquification reduces toggled-sets by up to 99.0%, 76.6% on average, and UNITs reduce toggled-sets by up to 99.4%, 83.9% on average. While all benchmarks benefit from UNITs over uniquification, benchmarks such as div, rle, intAVG, tHold, dhrystone_v2.1, dhyrstone_4mcu and coremark_v1.0 benefit significantly, showing 50.35% average reduction for UNITs relative to uniquification. Note that for the larger benchmarks (dhrystone_v2.1, dhrystone_4mcu and coremark_v1.0) the benefit of UNITs over uniquification is hard to distinguish in FIG. 4 (percent reduction metric), since both approaches result in very significant reduction of toggled-sets compared to basic graph-based DTA. Table III, however, provides the absolute results which show significant differences in the number of toggled sets.

### Applicability to Advanced Timing Analysis Techniques

Since the dynamic analysis techniques described herein are based on traditional timing analysis methodologies, they can easily be extended to advanced timing analysis techniques such as variation-aware analysis and multiple input switching (MIS). Below, some advanced timing techniques are listed that can easily be incorporated in the graph-based dynamic analysis approach. Note that other dynamic analysis approaches have not considered the advanced timing analysis techniques discussed below; however, they are mentioned here for completeness and to describe how they can be easily integrated into the approach. Also discussed is how to handle scenarios where the assumptions previously described are not valid (e.g., compound cells and false paths due to controlling inputs).

Removing Graph-Based Pessimism:

Since the technique leverages the benefits of graph-based STA for dynamic analysis, it inherently incorporates the pessimism of graph-based analysis. This is a well-known issue in traditional STA which has been addressed by using path-based analysis for the critical paths reported by graph-based STA to remove pessimism. The same approach can be applied on the UNITs of a benchmark to accurately report the slack of the dynamic critical paths. Also, such analysis can be restricted to the UNITs with near-critical slack (only 8.09% of UNITS, on average, where near-critical means: slack_{UNIT}≤slack_{dynamic critical path}+10%×clock period), so the cost of path-based analysis is significantly reduced by only analyzing the near-critical exercised paths, rather than all exercised paths (in the case of previous dynamic analysis techniques). Since they rely on path-based analysis, previous works do not suffer from graph-based pessimism; however, they would unnecessarily perform timing analysis on a large number of non-critical paths over a large number of redundant toggled-sets.

Compound Cells:

Some cells provided by a cell library are compound cells, such as a 2:1 MUX. For compound cells, it may be the case that a path through the cell can be considered as a false path, even though all gates on the path toggled. For example, if both the inputs of a MUX toggle, the path through one input can be marked as false, based on the value of the select pin. Similarly, the input to a tri-state buffer is marked as false if its enable pin is OFF. This functionality is easily incorporated in the analysis by tracking toggled pins rather than toggled gates. The rest of the analysis remains the same. Toggled pins completely and exclusively characterize all the toggled paths, and the optimizations are still valid on the new toggled-sets that consider toggled pins instead of gates.

Rise and Fall Toggled-Sets:

The results previously described were generated by considering both rise and fall transitions simply as toggles, rather than differentiating the two. Note that previous works on dynamic analysis also did not differentiate between rising and falling transitions. However, in some circumstances, differentiating rising and falling toggles could provide more accurate timing analysis. For completeness, the results in Table III were re-evaluated by differentiating rising and falling sets for pins, as well as false path marking for compound cells, and it was observed that the results only change by 3%, at the most, compared to basic DTA for any benchmark.

Multiple Input Switching:

If more than one input of a gate switches at the same time, the delay of the gate can be different than in the single input switching scenario traditionally assumed for STA. The graph-based analysis can easily perform more accurate timing analysis that accounts for multiple input switching, since the value of each pin can be tracked in the design from the VCD file and it can be determined when multiple inputs of the same gate toggle with similar arrival times/windows.

False Paths Due to Controlling Inputs:

If an input to a gate toggled to a controlling value, any other inputs that toggled to a non-controlling value can be marked as false. If multiple inputs of a toggled gate toggled to a controlling value in the same cycle, the slower transitioning path(s) can be considered false path(s). This is because the fast path toggles the gate's output first, precluding the effect of any slower path's toggle. The arrival times of the input pins of the toggled gate can be used to identify which controlling input arrives first, and the path(s) through the other pin(s) can be marked as false. Since the number of gates with multiple input switching is small, the overhead of checking the above conditions is negligible. Note that analysis of controlling inputs would likely have significantly higher overhead for path-based techniques, since the same gate would be analyzed multiple times (once per toggled path it is in). Since variations may affect which input arrives first to a gate, false paths were not marked due to fast-arriving controlling inputs for the analysis.

Statistical Static Timing Analysis, Multi-Mode, Multi-Corner, and On-Chip Variation Analyses:

Since SSTA can be graph-based and also be applied incrementally, the method described herein, which is based on pruning a design then applying STA, can easily incorporate SSTA. On-chip variation analyses such as Parametric On-chip Variation analysis are inherited from SSTA. Having a graph-based and path-based version these analyses are easily incorporated into the methodology. MMMC techniques involve re-running timing analysis for various modes at various corners, which can easily be performed with the approach.

Crosstalk Analysis:

Crosstalk analysis can easily be included in the methodology, since transitions (rise/fall) and values on nets and pins for crosstalk analysis can be excluded/included using commands such as set_si_delay_analysis and set_case_analysis provided by PrimeTime.

### Reporting the N Worst Exercised Paths Sorted by Timing Critically

The N worst exercised paths are identified from one or more gate-level simulations in decreasing order of critically based on a metric. The metrics that may be used include:

1) Timing critically of a path
2) Activity of a path
3) Activity of paths that have a timing slack within a given range of values.
Algorithm 5 describes reporting the N worst exercised paths sorted by timing critically. Algorithm 5 is executed after the UNIT identification previously described with reference to Algorithm 3 (lines 1-21) above.

Algorithm 5. Pseudocode to report the N worst
exercised paths sorted by timing critically

```
Procedure Find_Nworst_Exercised_Timing_Critical_Paths(N,
netlist, VCD)
1. U ← Generate_UNITs(netlist, VCD)
2. U ← Index_UNITS(U)
3. foreach Gate g ∈ netlist do
4. u_{g} ← genUNITMembershipArray(g, U) // bit vector
          indicating g's membership in each UNIT
5. end for
6. H ← Ø // min_heap of path segments, minimizes on timing slack
7. P ← Ø // set of explored paths
8. foreach Path Endpoint e ∈ netlist do
9. e.key ← min slack of any path containing e
10. H.push(e)
11. end for
12. while size(P) < N do
13. p ← H.pop( ) // Path Segment with worst slack
14. if p is a full path then
15. P.append(p)
16. continue
17. end if
18. uₚ ← getUNITMembershipArray(p) //member
          vector for Path Segment p
19. foreach g ∈ fanin(p) do
20. u_{g} ← getUNITMembershipArray(g) // member
              vector for Gate g
21. if scalar_product(u_{g}, uₚ) > 0 then
22. s ← p.prepend(g) // new path segment with
                  g added to p
23. uₛ ← u_{g}&uₚ // bitwise &
24. H.push(s)
25. end if
26. end for
27. end while
```

Algorithm 5 has three inputs. The first input is N, the number of exercised paths to be reported in decreasing order of metric criticality. The second input is the activity file(s) generated as output from one or more gate-level simulations on the same design. An example activity file would be a VCD file or a VPD file generated by Synopsys VCS. The third input is the design connectivity information, such as which gates is a given gate connected to. Taking these three inputs, the algorithms generate the list of N worst exercised paths in decreasing order of criticality of the three metrics described earlier—timing, activity, activity within a timing slack range. Below, Algorithm 5 is described which takes the above three inputs and generates the list of N worst exercised paths in terms of timing criticality.

1) The algorithm reads in the activity file and generates toggled-sets for each cycle information.
2) Generate the UNITs from the toggled-sets and index them.
3) Using the indexed list of UNITs, generate a UNIT Membership array for each gate (pin or net) in the design. A UNIT Membership array is just a bit vector representing whether a gate belongs to a particular UNIT or not. For example, an array of 1001 means that the gate belongs to UNITs 1 and 4 and does not belong to UNITs 2 and 3.
4) Initialize two data structures:

a. A min_heap of path segments that stores path segments as the design is explored. The heap minimizes on timing slack of the path segments. That is, it will sort all the path segments in the increasing order of slack so that the path segment on top of the heap is the path segment with the least slack.

b. A List of the explored paths (full paths, not path segments), reported in order of decreasing timing criticality.

5) After initializing the two data structures, insert all the design endpoints (such as flip-flops and output ports) into the heap. The key value for each endpoint (path segment) is the minimum slack of any path through that endpoint (path segment). Note that the smallest non-empty path segment is a single gate or a port.
6) Pop the top path segment from the heap. When done the first time, it gets the endpoint with the least timing slack. That is the endpoint for which the longest path through the endpoint has the least slack.
7) If this path segment is actually a full path, then append this path to the list of explored paths. This is the next worst path in order of criticality.
8) If this path segment is not a full path, pick each fanin gate (or net or pin) of the gate at the extendible end of the path segment and add it to the path segment to produce a new path segment. For each of the new path segments produced, do the following:

a. Compute the UNIT Membership array for the new path segment. This is achieved by performing a bitwise AND of the UNIT Membership arrays of the original path segment and the newly added gate.

b. If the new path segment belongs to at least one UNIT (sum of the values of the UNIT membership array is non-zero), this path segment was exercised during the gate-level simulation(s) and so push it onto the heap for future analysis, using the worst slack of any path through the path segment as its sorting key in the heap.

9) Keep iterating from step 6 to 9 until the number of explored paths equals N (the requested number).
Getting the N Worst Exercised Paths in Terms of Activity within a Slack Range

The next Algorithm 6 follows the same structure as Algorithm 5 above. Algorithm 6 returns the N most active paths from one or more gate level simulations on the same design. This algorithm uses UTs (Unique Toggled-sets) instead of UNITs, since UNITs cannot be used to characterize gate or path activity rates. Algorithm 6 is executed after identifying UTs as previously described with reference to Algorithm 2 (lines 1-14) above.

Algorithm 6. Pseudocode to Get the N Worst Exercised
Paths in Terms of Activity within a Slack Range

```
Procedure Find_Nworst_Active_Paths(N, netlist, VCD, Sₘᵢₙ, Sₘₐₓ) //
num paths, min_slack, max_slack
1. U ← Generate_UTs(netlist, VCD)
2. T ← getToggleRatesOfUTs(U)
3. U ← Index UTs(U)
4. foreach Gate g in netlist do
5. u_{g} ← genUTMembershipArray(g, U) // bit vector
          indicating g's membership in each UT
6. end for
7. H ← max_heap of path segments. // Maximizes on path
      segment activity
8. P ← Ø // set of explored paths
9. foreach Path Endpoint e do
10. H.push(e)
11. tₑ ← scalar product(uₑ, T)
12. end for
13. while size(P) < N do
14. p ← H.pop( ) // Path Segment
15. if p is a full path then
16. P.push(p)
17. continue
18. end if
19. foreach g ∈ fanin(p) do
20. u_{g} ← getUTMembershipArray(g) // Gate g
21. uₚ ← getUTMembershipArray(p) // Path Segment p
22. s ← p.prepend(g) // generate new path segment s
23. uₛ ← u_{g}&uₚ // bitwise &
24. tₛ ← scalar product (uₛ, T) // toggle count of this
              path segment
25. S_{Smin} ← getLowestTimingSlackThrough(s) // slack
              of longest path through segment s
26. S_{Smax} ← getHighestTimingSlackThrough(s) // slack
              of shortest path through segment s
27. if [S_{Smin}, S_{Smax}] ∩ [Sₘᵢₙ, Sₘₐₓ] ≠ Ø then
28. H.push(s)
29. end if
30. end for
31. end while
```

Algorithm 6 has the same three inputs as Algorithm 5-N, activity file, and design connectivity information. It also takes another input—the slack range in which the paths need to be reported. That is, the algorithm returns the N most active paths within a specified slack range.

1) The algorithm reads in the activity file and generates toggled-sets for each cycle information.
2) Generate the UTs from the toggled-sets and index them.
3) During the generation of the UTs keep count of how many times a UT occurred, which is the toggle count of a UT. Generate a vector of the toggle counts of all the UTs. The vector is indexed in the same order as the indices of the UTs.
4) Using the indexed list of UTs generate a UT Membership array for each gate (or pin or net) in the design. A UT Membership array is a bit vector representing whether a gate belongs to a particular UT or not. For example, an array of 1001 means that the gate belongs to UTs 1 and 4 and does not belong to UTs 2 and 3.
5) Initialize two data structures:

a. A max_heap of path segments that stores path segments as the design is explored. The heap maximizes on toggle count of the path segments. That is, it will sort all the path segments in the decreasing order of toggle count so that the path segment on top of the heap is the path segment with the largest toggle count.

b. A List of the explored paths (full paths, not path segments).

6) After initializing the two data structures, insert all the design endpoints (such as flip-flops and output ports) that belong to any path within the specified slack range into the heap. The key value for each endpoint (path segment) is the toggle count of that endpoint (path segment). Note that the smallest non-empty path segment is a single gate or port.
7) Pop the top path segment from the heap. When done the first time, it gets the endpoint with the highest toggle count.
8) If this path segment is actually a full path, then push this path into the list of explored paths. This is the next worst path in order of activity in the given slack range. In other words, this is the path with the next highest toggle count within the slack range.
9) If this path segment is not a full path, pick each fanin gate (or net or pin) of the gate at the extendible end of the path segment and add it to the path segment to produce a new path segment. For each of the new path segments produced, do the following:

a. Check if the slack of any path through this path segment is within the requested slack range. If not, the segment is discarded.

b. If the slack check passes, compute the UT Membership array for the new path segment. This is achieved by performing a bitwise AND of the UT Membership array of the original path segment and the newly added gate.

c. Compute the scalar product of the new segment's UT Membership array and the UT Toggle count array generated at the start of this algorithm. This gives the toggle count of the new path segment.

d. Push the new path segment onto the heap for future analysis, using the toggle count of the endpoint (path segment) as its sorting key in the heap.

10) Keep iterating from step 7 to 9 until the number of explored paths equals N (the requested number).

In another example, Algorithm 6 may exclude the slack range such that the algorithm finds the N worst exercised paths in terms of activity without regard to a slack range. For example, Algorithm 6 could be modified to remove lines 25, 26, 27, and 29.

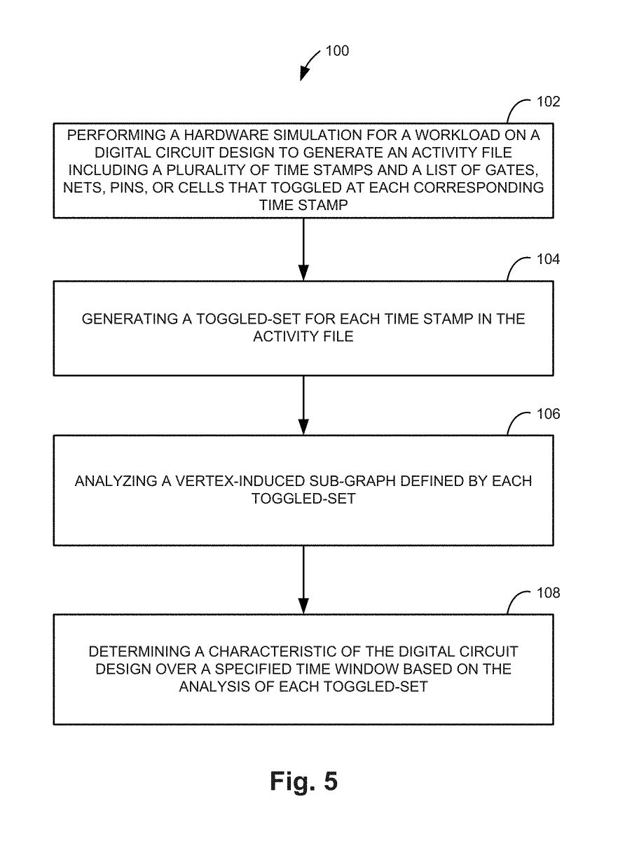

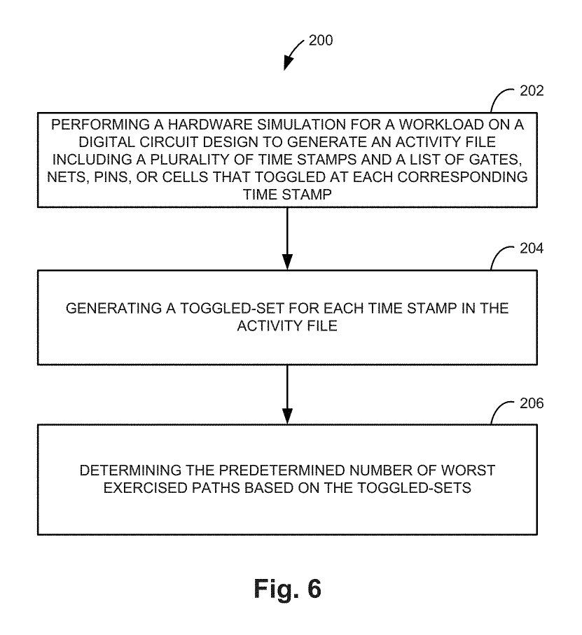

The following FIGS. 5 and 6 illustrate example methods for implementing the processes described above. FIG. 5 is a flow diagram illustrating one example of a method 100 for analyzing a digital circuit. At 102, method 100 includes performing a hardware simulation (e.g., gate-level or RTL simulation) for a workload on a digital circuit design to generate an activity file including a plurality of time stamps and a list of gates, nets, pins, or cells that toggled at each corresponding time stamp. Performing the hardware simulation may include performing a symbolic simulation. At 104, method 100 includes generating a toggled-set for each time stamp in the activity file. At 106, method 100 includes analyzing a vertex-induced sub-graph defined by each toggled-set. In one example, analyzing the vertex-induced sub-graph defined by each toggled-set includes performing activity analysis on the vertex-induced sub-graph defined by each toggled-set. In another example, analyzing the vertex-induced sub-graph defined by each toggled-set includes performing timing analysis on the vertex-induced sub-graph defined by each toggled-set. At 108, method 100 includes determining a characteristic of the digital circuit design over a specified time window based on the analysis of each toggled-set. In one example, the characteristic of the digital circuit design includes one of a dynamic critical path, statistical static timing, on-chip variations, crosstalk, and path toggle rates.

Method 100 may further include uniquifying the toggled-sets to provide unique toggled sets (UTs). Live UTs may be extracted from the UTs. In this case, analyzing the vertex-induced sub-graph defined by each toggled-set includes analyzing a vertex-induced sub-graph defined by each UT or each live UT. Method 100 may further include identifying unique non-includible toggled-sets (UNITs). Live UNITs may be extracted from the UNITs. In this case, analyzing the vertex-induced sub-graph defined by each toggled-set includes analyzing a vertex-induced sub-graph defined by each UNIT or each live UNIT. Method 100 may also include extracting live toggled-sets from the toggled-sets. Live UTs or live UNITs may be identified from the live toggled-sets. In this case, analyzing the vertex-induced sub-graph defined by each toggled-set includes analyzing a vertex-induced sub-graph defined by each live toggled-set, each live UT, or each live UNIT.

Method 100 may also include identifying rising toggled-sets from the toggled-sets. In this case, analyzing the vertex-induced sub-graph defined by each toggled-set includes analyzing a vertex-induced sub-graph defined by each rising toggled-set. Method 100 may also include identifying falling toggled-sets from the toggled-sets. In this case, analyzing the vertex-induced sub-graph defined by each toggled-set includes analyzing a vertex-induced sub-graph defined by each falling toggled-set.

FIG. 6 is a flow diagram illustrating one example of a method 200 to report a predetermined number of worst exercised paths of a digital circuit. At 202, method 200 includes performing a hardware simulation (e.g., gate-level or RTL simulation) for a workload on a digital circuit design to generate an activity file including a plurality of time stamps and a list of gates, nets, pins, or cells that toggled at each corresponding time stamp. At 204, method 200 includes generating a toggled-set for each time stamp in the activity file. At 206, method 200 includes determining the predetermined number of worst exercised paths based on the toggled-sets. In one example, determining the predetermined number of worst exercised paths includes determining the predetermined number of worst exercised paths sorted by timing criticality. In another example, determining the predetermined number of worst exercised paths includes determining the predetermined number of worst exercised paths in terms of activity. In yet another example, determining the predetermined number of worst exercised paths includes determining the predetermined number of worst exercised paths in terms of activity within a slack range.

Method 200 may further include identifying unique non-includible toggled-sets (UNITs) from the toggled-sets. In this case, determining the predetermined number of worst exercised paths includes determining the predetermined number of worst exercised paths based on the UNITs. Method 200 may further include uniquifying the toggled-sets to provide unique toggled sets (UTs). In this case, determining the predetermined number of worst exercised paths includes determining the predetermined number of worst exercised paths based on the UTs.

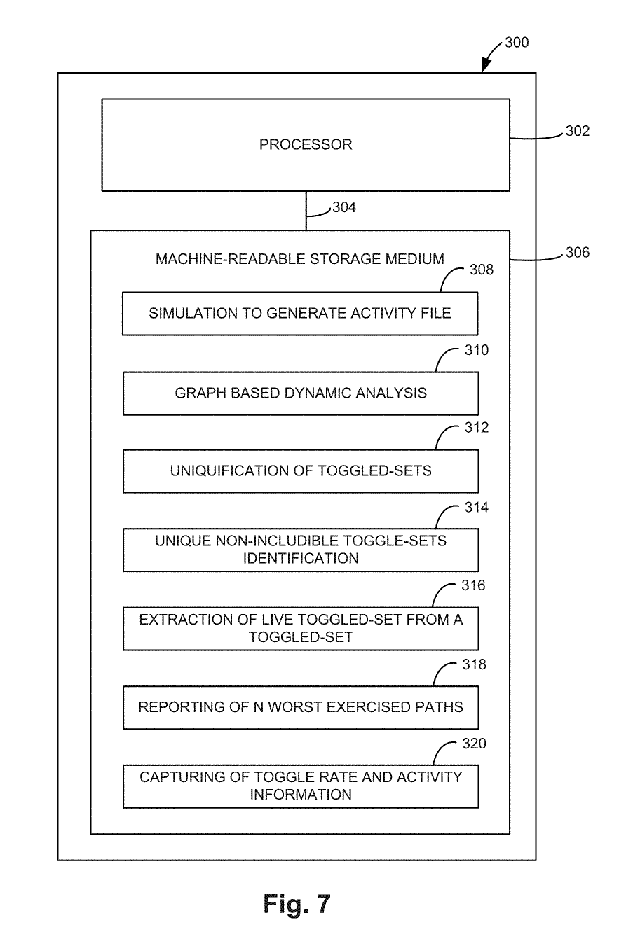

FIG. 7 is a block diagram illustrating one example of a processing system 300 for implementing the methods previously described herein. System 300 includes a processor 302 and a machine-readable storage medium 306. Processor 302 is communicatively coupled to machine-readable storage medium 306 through a communication path 304. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 302 includes one or more central processing units (CPUs), microprocessors, and/or other suitable hardware devices for retrieval and execution of instructions stored in machine-readable storage medium 306. Processor 302 may fetch, decode, and execute instructions 308 to implement a simulation to generate an activity file as previously described herein. Processor 302 may fetch, decode, and execute instructions 310 to implement graph based dynamic analysis as previously described herein. Processor 302 may fetch, decode, and execute instructions 312 to implement the uniquification of toggle-sets as previously described herein. Processor 302 may fetch, decode, and execute instructions 314 to implement unique non-includible toggle-sets identification as previously described herein. Processor 302 may fetch, decode, and execute instructions 316 to implement the extraction of a live toggled-set from a toggled-set as previously described herein. Processor 302 may fetch, decode, and execute instructions 318 to implement reporting of N worst exercised paths as previously described herein. Processor 302 may fetch, decode, and execute instructions 320 to implement the capturing of toggle rate and activity information as previously described herein.

As an alternative or in addition to retrieving and executing instructions, processor 302 may include one or more electronic circuits comprising a number of electronic components for performing the functionality of one or more of the instructions in machine-readable storage medium 306. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 306 is a non-transitory storage medium and may be any suitable electronic, magnetic, optical, or other physical storage device that stores executable instructions. Thus, machine-readable storage medium 306 may be, for example, random access memory (RAM), an electrically-erasable programmable read-only memory (EEPROM), a storage drive, an optical disc, and the like. Machine-readable storage medium 306 may be disposed within system 300, as illustrated in FIG. 7. In this case, the executable instructions may be installed on system 300. Alternatively, machine-readable storage medium 306 may be a portable, external, or remote storage medium that allows system 300 to download the instructions from the portable/external/remote storage medium. In this case, the executable instructions may be part of an installation package.

### CONCLUSION

The implementation of the techniques disclosed herein do not necessarily need to include generating and subsequently reading an activity file (e.g., a VCD file). The techniques may also be implemented to perform analysis on the fly during activity analysis or generation of an activity file. The techniques may also be extended to regular register-transfer level (RTL) simulations, where the RTL design is realized as a graph of functions instead of gates. The techniques may be realized fully or partially in the form of a field-programmable gate array (FPGA), a graphics processing unit (GPU), or an application-specific integrated circuit (ASIC) implementation. The toggled-sets may be generated from multiple simulations instead of a single simulation. The techniques can be applied to toggles nets and toggles pins in addition to toggled gates. In the described techniques, wherever UNITs are used, UTs or regular toggled-sets could be used, and wherever UTs are used, regular toggled-sets could be used. While this may impact performance, it will have no effect on the results. The techniques are applicable to any application specific analysis for power management.

Path-based dynamic analysis tools used by existing BTWC techniques to analyze timing and activity information do not scale to larger designs or analysis time windows. The novel graph-based dynamic analysis methodology described herein is not only scalable but also significantly faster than previous tools. Also, the methodology is easily integrated with industry-standard CAD tools. The methodology is further improved with two optimizations—uniquification of toggled-sets and Unique Non-Includible Toggled-sets (UNITs). The results demonstrate 105.6× speedup compared to path-based DTA and 93.8%, 96.9% average reduction in analyzed toggled-sets for uniquification and UNITs, respectively.

While the techniques are described in terms of tracing back from path end-points, it is also possible to implement the techniques by tracing from the path start-points. An alternate method to implement the algorithms is by having a single source and single sink node connected to all the path start-points and path end-points, respectively. The source and sink nodes are assumed to toggle every cycle, and the edges from and to these nodes, respectively, are assumed to have zero delay.

Although the present disclosure has been described with reference to preferred embodiments, workers skilled in the art will recognize that changes can be made in form and detail without departing from the spirit and scope of the present disclosure.

What is claimed is:

1. A method for analyzing a digital circuit, the method comprising:
performing a hardware simulation for a workload on a digital circuit design to generate an activity file including a plurality of time stamps and a list of gates, nets, pins, or cells that toggled at each corresponding time stamp;
generating a toggled-set for each time stamp in the activity file;
analyzing a vertex-induced sub-graph defined by each toggled-set; and
determining a characteristic of the digital circuit design over a specified time window based on the analysis of each toggled-set.

2. The method of claim 1, wherein analyzing the vertex-induced sub-graph defined by each toggled-set comprises performing activity analysis on the vertex-induced sub-graph defined by each toggled-set.

3. The method of claim 1, wherein analyzing the vertex-induced sub-graph defined by each toggled-set comprises performing timing analysis on the vertex-induced sub-graph defined by each toggled-set.

4. The method of claim 1, further comprising:
uniquifying the toggled-sets to provide unique toggled sets (UTs),
wherein analyzing the vertex-induced sub-graph defined by each toggled-set comprises analyzing a vertex-induced sub-graph defined by each UT.

5. The method of claim 4, further comprising:
extracting live UTs from the UTs,
wherein analyzing the vertex-induced sub-graph defined by each toggled-set comprises analyzing a vertex-induced sub-graph defined by each live UT.

6. The method of claim 1, further comprising:
identifying unique non-includible toggled-sets (UNITs),
wherein analyzing the vertex-induced sub-graph defined by each toggled-set comprises analyzing a vertex-induced sub-graph defined by each UNIT.

7. The method of claim 6, further comprising:
extracting live UNITs from the UNITs,
wherein analyzing the vertex-induced sub-graph defined by each toggled-set comprises analyzing a vertex-induced sub-graph defined by each live UNIT.

8. The method of claim 1, further comprising:
extracting live toggled-sets from the toggled-sets,
wherein analyzing the vertex-induced sub-graph defined by each toggled-set comprises analyzing a vertex-induced sub-graph defined by each live toggled-set.

9. The method of claim 8, further comprising:
uniquifying the live toggled-sets to provide live unique toggled sets (UTs),
wherein analyzing the vertex-induced sub-graph defined by each toggled-set comprises analyzing a vertex-induced sub-graph defined by each live UT.

10. The method of claim 8, further comprising:
identifying live unique non-includible toggled-sets (UNITs) from the live toggled-sets,
wherein analyzing the vertex-induced sub-graph defined by each toggled-set comprises analyzing a vertex-induced sub-graph defined by each live UNIT.

11. The method of claim 1, further comprising:
identifying rising toggled-sets from the toggled-sets,
wherein analyzing the vertex-induced sub-graph defined by each toggled-set comprises analyzing a vertex-induced sub-graph defined by each rising toggled-set.

12. The method of claim 1, further comprising:
identifying falling toggled-sets from the toggled-sets,
wherein analyzing the vertex-induced sub-graph defined by each toggled-set comprises analyzing a vertex-induced sub-graph defined by each falling toggled-set.

13. The method of claim 1, wherein the characteristic of the digital circuit design includes a characteristic reportable by at least one of static timing analysis, statistical static timing analysis, on-chip variation analysis, crosstalk analysis, and path toggle rate characterization.

14. The method of claim 1, wherein performing the hardware simulation comprises performing a symbolic simulation.

15. A method to report a predetermined number of worst exercised paths of a digital circuit, the method comprising:
performing a hardware simulation for a workload on a digital circuit design to generate an activity file including a plurality of time stamps and a list of gates, nets, pins, or cells that toggled at each corresponding time stamp;
generating a toggled-set for each time stamp in the activity file; and
determining the predetermined number of worst exercised paths based on the toggled-sets.

16. The method of claim 15, further comprising:
identifying unique non-includible toggled-sets (UNITs) from the toggled-sets, wherein determining the predetermined number of worst exercised paths comprises determining the predetermined number of worst exercised paths based on the UNITs.

17. The method of claim 15, further comprising:
uniquifying the toggled-sets to provide unique toggled sets (UTs), wherein determining the predetermined number of worst exercised paths comprises determining the predetermined number of worst exercised paths based on the UTs.

18. The method of claim 15, wherein determining the predetermined number of worst exercised paths comprises determining the predetermined number of worst exercised paths sorted by timing criticality.

19. The method of claim 15, wherein determining the predetermined number of worst exercised paths comprises determining the predetermined number of worst exercised paths in terms of activity.

20. The method of claim 15, wherein determining the predetermined number of worst exercised paths comprises determining the predetermined number of worst exercised paths in terms of activity within a slack range.
